(19) United States
(12) Patent Application Publication
(10) Pub. No.: US 2025/0286810 A1
(43) Pub. Date: Sep. 11, 2025

(54) Network path state detection

(71) Applicant: MELLANOX TECHNOLOGIES, LTD., Yokneam (IL)

(72) Inventors: Elazar Cohen, Haifa (IL); Eitan Zahavi, Zichron Yaakov (IL); Idan Borshteen, Carmiel (IL); Yamin Friedman, Jerusalem (IL); Yuval Shpigelman, Netanya (IL); Ariel Shahar, Jerusalem (IL)

(21) Appl. No.: 19/063,380

(22) Filed: Feb. 26, 2025

Related U.S. Application Data
(60) Provisional application No. 63/561,753, filed on Mar. 6, 2024.

(51) Int. Cl. H04L 45/12; H04L 47/12; H04L 69/22

(52) U.S. Cl. CPC H04L 45/12; H04L 47/12; H04L 69/22

(57) ABSTRACT

In one embodiment, a sender node includes packet processing circuitry to associate, at layer 2 or 3 of Open Systems Interconnection (OSI) model, path identifiers and per-path packet sequence numbers with packets, wherein the path identifiers identify paths from the sender node to receiver nodes, and an interface to send the packets with the associated packet sequence numbers and path identifiers to the receiver nodes.

### RELATED APPLICATION INFORMATION

The present application claims benefit of U.S. Provisional Patent Application Ser. No. 63/561,753 of Cohen, et al., and entitled “Network packet drop packet detection with Adaptive Routing” filed 6 Mar. 2024, the disclosure of which is hereby incorporated herein by reference.

### FIELD OF THE DISCLOSURE

The present disclosure relates to computer networks, and in particular, but not exclusively to, network path state.

### BACKGROUND

When data packets are transmitted across a lossy network, some are inevitably lost due to various factors. One common cause of packet loss is network congestion. When too many devices or applications compete for bandwidth, the network becomes overloaded, and routers may drop packets to prioritize other traffic. As congestion increases, packet loss becomes more frequent, leading to slower speeds and delays in communication.

Faulty or degraded hardware can also contribute to packet loss. Malfunctioning routers, switches, or cables may fail to forward packets properly, often due to aging equipment or physical damage. Additionally, network failures, such as outages in communication links, can cause packets to be lost until the issue is resolved or rerouted through a different path.

While packet loss is a natural part of communication in lossy networks, frequent loss can negatively affect network performance and service quality.

### OVERVIEW

There is provided in accordance with an embodiment of the present disclosure, a sender node comprising packet processing circuitry to associate, at layer 2 or 3 of the Open Systems Interconnection (OSI) model, at least a portion of path identifiers and at least a portion of per-path packet sequence numbers with packets, wherein the path identifiers identify paths from the sender node to receiver nodes; and an interface to send the packets with the associated packet sequence numbers and path identifiers to the receiver nodes.

Further in accordance with an embodiment of the present disclosure, the sender node's packet processing circuitry is to add the path identifiers and the per-path packet sequence numbers to packet headers of the packets at layer 2 or 3.

Still further in accordance with an embodiment of the present disclosure, the sender node's packet processing circuitry is to add the path identifiers and the per-path packet sequence numbers to metadata associated with packets at layer 2 or 3.

Additionally in accordance with an embodiment of the present disclosure, the interface is to send the packets over a network to the receiver nodes which include at least one endpoint device, the sender node being a network switch or an endpoint device.

Moreover, in accordance with an embodiment of the present disclosure, the interface is to send the packets over a network to the receiver nodes, the receiver nodes including at least one network switch.

Further in accordance with an embodiment of the present disclosure, the sender node is a network switch.

Still further in accordance with an embodiment of the present disclosure, the sender node is comprised in an input port of a network switch, and the receiver nodes are comprised in respective output ports of the network switch, the path identifiers identifying the paths between the input port and the output ports of the switch.

Additionally in accordance with an embodiment of the present disclosure, the interface is to receive the packets from other nodes in a network; and the packet processing circuitry is to augment existing path identifiers of the packets based on the paths between the sender node and the receiver nodes of the packets.

There is provided in accordance with another embodiment of the present disclosure, a receiver node comprising an interface to receive from sender nodes packets with associated path identifiers and per-path packet sequence numbers, at least a portion of the path identifiers and at least a portion of the packet sequence numbers being associated at layer 2 or 3 of the Open Systems Interconnection (OSI) model with the packets; and packet processing circuitry to analyze the received packets at the layer 2 or 3 based on the at least portion of the packet sequence numbers and the at least portion of the path identifiers; and determine data indicative of states of paths identified by the path identifiers based on the analysis at the layer 2 or 3 of the received packets.

Further in accordance with an embodiment of the present disclosure, the path identifiers and the per-path packet sequence numbers are received from the sender nodes in packet headers of the packets at layer 2 or 3.

Still further in accordance with an embodiment of the present disclosure, the path identifiers and the per-path packet sequence numbers are included in metadata associated with packets at layer 2 or 3.

Additionally in accordance with an embodiment of the present disclosure, the packet processing circuitry is to identify packet loss between the sender nodes and the receiver node based on the packet sequence numbers at layer 2 or 3; and determine the data indicative of the states of the paths based on the identified packet loss.

Moreover, in accordance with an embodiment of the present disclosure, the packet processing circuitry is to generate telemetry data indicative of the states of the paths identified by the path identifiers based on the analysis of the received packets; and provide the telemetry data to a collector to perform network analysis.

Further in accordance with an embodiment of the present disclosure, the packet processing circuitry is to generate congestion control data based on a state of a given one of the paths based on the analysis at the layer 2 or 3 of the received packets.

Still further in accordance with an embodiment of the present disclosure, the packet processing circuitry is to request retransmission of one or more given packets based on a state of a given one of the paths based on the analysis at the layer 2 or 3 of the received packets.

Additionally in accordance with an embodiment of the present disclosure, the interface is to receive the packets over a network from the sender nodes, the sender nodes including at least one endpoint device, the receiver node being a network switch or an endpoint device.

Moreover, in accordance with an embodiment of the present disclosure, the interface is to receive the packets over a network from the sender nodes, the sender nodes including at least one network switch.

Further in accordance with an embodiment of the present disclosure, the receiver node is a network switch.

Still further in accordance with an embodiment of the present disclosure, the sender nodes are comprised in respective input ports of a network switch, and the receiver node is comprised in an output port of the network switch, wherein the path identifiers identify the paths between the input ports and the output port of the switch.

There is also provided in accordance with still another embodiment of the present disclosure, a system comprising sender nodes to associate, at layer 2 or 3 of the Open Systems Interconnection (OSI) model, at least a portion of path identifiers and at least a portion of per-path packet sequence numbers with packets, wherein the path identifiers identify paths from the sender nodes to receiver nodes; and send the packets with the associated packet sequence numbers and path identifiers to the receiver nodes; and receiver nodes to receive from the sender nodes the packets with the associated path identifiers and per-path packet sequence numbers; analyze the received packets at the layer 2 or 3 based on the at least a portion of the packet sequence numbers and the at least a portion of the path identifiers; and determine data indicative of states of paths identified by the path identifiers based on the analysis at layer 2 or 3 of the received packets.

Further in accordance with an embodiment of the present disclosure, the sender nodes are to add the path identifiers and the per-path packet sequence numbers to packet headers of the packets at layer 2 or 3.

Still further in accordance with an embodiment of the present disclosure, the sender nodes are to add the path identifiers and the per-path packet sequence numbers to metadata associated with packets at layer 2 or 3.

Additionally in accordance with an embodiment of the present disclosure, at least one of the receiver nodes is to identify packet loss between the sender nodes and the at least one receiver node based on the packet sequence numbers at layer 2 or 3; and determine the data indicative of the states of the paths based on the identified packet loss.

Moreover, in accordance with an embodiment of the present disclosure, the receiver nodes are to generate telemetry data indicative of the states of the paths identified by the path identifiers based on the analysis of the receiver packets; and provide the telemetry data to a collector to perform network analysis.

Further in accordance with an embodiment of the present disclosure, at least one of the receiver nodes is to generate congestion control data based on at least one state of at least one given one of the paths based on the analysis at the layer 2 or 3 of the received packets.

Still further in accordance with an embodiment of the present disclosure, at least one of the receiver nodes is to request retransmission of one or more given packets based on at least one state of at least one given one of the paths based on the analysis at the layer 2 or 3 of the received packets.

Additionally in accordance with an embodiment of the present disclosure, the receiver nodes are to receive the packets over a network from the sender nodes, the sender nodes including at least one endpoint device, the receiver nodes including at least one network switch or at least one endpoint device.

Moreover, in accordance with an embodiment of the present disclosure, the receiver nodes are to receive the packets over a network from the sender nodes, the sender nodes including at least one network switch.

Further in accordance with an embodiment of the present disclosure, the receiver nodes include at least one network switch.

Still further in accordance with an embodiment of the present disclosure, the system further comprises an orchestration node to define an initial set of the sender nodes and the receiver nodes for collection of an initial set of the telemetry data indicative of the state of some of the paths; receive the initial set of the telemetry data; analyze the initial set of the telemetry data to determine that a given path is unhealthy; define another set of the sender nodes and the receiver nodes to generate an additional set of the telemetry data with respect to possible sub-paths of the given path; receive the additional set of the telemetry data; and analyze the additional set of the telemetry data of the sub-paths to determine that one of the sub-paths is unhealthy.

There is also provided in accordance with yet another embodiment of the present disclosure, a method at a sender node comprising associating, at layer 2 or 3 of the Open Systems Interconnection (OSI) model, at least a portion of path identifiers and at least a portion of per-path packet sequence numbers with packets, wherein the path identifiers identify paths from the sender node to receiver nodes, and sending the packets with the associated packet sequence numbers and path identifiers to the receiver nodes.

There is also provided in accordance with a further embodiment of the present disclosure, a method at a receiver node comprising receiving from sender nodes packets with associated path identifiers and per-path packet sequence numbers, at least a portion of the path identifiers and at least a portion of the packet sequence numbers being associated at layer 2 or 3 of the Open Systems Interconnection (OSI) model with the packets, analyzing the received packets at the layer 2 or 3 based on the at least portion of the packet sequence numbers and the at least portion of the path identifiers, and determining data indicative of states of paths identified by the path identifiers based on the analysis at the layer 2 or 3 of the received packets.

### BRIEF DESCRIPTION OF THE DRAWINGS

The present disclosure will be understood from the following detailed description, taken in conjunction with the drawings in which:

FIG. 1 is a block diagram view of a computer system constructed and operative in accordance with an embodiment of the present disclosure;

FIG. 2 is a block diagram view of a network switch in the system of FIG. 1;

FIG. 3 is a flowchart including steps in a method of operation of a sender node in the system of FIG. 1;

FIG. 4 is a flowchart including steps in a method of operation of a receiver node in the system of FIG. 1;

FIG. 5 is a flowchart including steps in a method of operation of an orchestration node in the system of FIG. 1; and

FIG. 6 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

As previously mentioned, when data packets are transmitted across a lossy network from one endpoint to another, some packets inevitably get lost along the way. This can occur due to a variety of factors such as congestion, faulty hardware, or network failures.

The first challenge in managing this is detecting that a packet has been lost in the first place, as there are often no immediate indications that a specific packet was not delivered successfully.

The second challenge involves tracing the path that the lost packet took, which is crucial for diagnosing the issue. Identifying the precise route of a lost packet will allow network administrators to pinpoint the source of the failure. For instance, if a certain network path is determined to be faulty, it can be reported to the administrator so that corrective actions can be taken, such as fixing the path, resetting switches, avoiding the problematic path, or reconfiguring the network to bypass the failure.

A significant issue arises when a packet is lost, as it becomes difficult to know which specific path the packet was transmitted along before it was dropped. This lack of visibility into the network path complicates fault identification and resolution. While some network devices, like switches, might have records of packet transmission, the level of visibility they provide is often limited. Switches primarily operate at the data link (Layer 2) or network layer (Layer 3), and do not have direct access to higher layers, such as the transport layer (Layer 4), where the loss of individual packets is tracked.

At the transport layer, protocols can identify when packets are lost and request retransmission. However, the problem persists that the transport layer does not inherently have visibility into which physical or logical path the packet followed. This gap is significant because the path information may reside in the switches or routers handling the data, but those devices typically do not process data at the transport layer level.

Moreover, at Layer 4, managing paths becomes even more complex due to the way queue pairs (QPs) are used in transport protocols like RDMA (Remote Direct Memory Access). A QP represents the connection between a send queue on a transmitting device and a receive queue on a receiving device. However, because each transport layer connection involves a QP, and because multiple flows between the same endpoints can share the same underlying physical or logical path, tracking individual QPs becomes an impractical solution. The sheer number of QPs makes it difficult to correlate packet loss with specific flows or paths, especially in large-scale networks where numerous paths are available for routing data.

Therefore, the core issues stem from the lack of visibility at the transport layer regarding which path a packet took, and the difficulty in tracking the individual QPs that might correspond to different flows between the same endpoints. This makes it challenging to identify packet loss location accurately and address underlying network issues.

Embodiments of the present disclosure address at least some of the above drawbacks providing a holistic picture of the network paths and their state (e.g., health) at layer 2/3 (of Open Systems Interconnection (OSI) model) by associating (at least a portion of) path identifiers and (at least a portion of) per-path packet sequence numbers (PSNs) with packets at layer 2/3 for paths between endpoints, and/or between endpoints and one or more switches, and/or between switches, and/or and within one or more switches to better understand the state of network paths.

Network nodes may add (at least a portion of) packet sequence numbers at layer 2 or 3 and path IDs to packets so that network nodes receiving the packets can track dropped packets per path and know the number or fraction of dropped packets based on the PSNs. At least a portion of the path identifier identifying the sender network node and the receiver network node is added to the packet at layer 2 or 3. The path could be defined by the source and destination addresses of the sender and receiver network nodes. The paths are not identified by queue pairs (QPs). As packets for a given path are assigned packet sequence numbers for that path, the number of dropped packets, or arrived packets, or some indication of packet loss or arrival success may be determined by the receiving network node (e.g., endpoint) to provide an indication of a state (e.g., health) of the path.

As previously mentioned, the receiver node may identify dropped packets per-path from the packet sequence numbers allowing path state to be estimated. The receiver nodes may generate telemetry data indicative of the state of the paths and provide the telemetry data to a collector to perform network analysis. The receiver node may generate congestion control data based on the state(s) of the path(s) and/or may request retransmission of one or more packets based on the state(s) of the path(s).

A sender node may refer to an endpoint device that sends a packet, or to a switch or a port of a switch or any suitable network node that forwards the packet. A receiver node may refer to an endpoint device that receives a packet, or to a switch or a port of a switch or any suitable network node that receives the packet for forwarding to another network node.

The analysis of the paths may lead to further analysis of other paths and sub-paths. The data regarding the dropped packets of a given path may indicate that the given path between two network nodes (e.g., endpoints) has problems, but may not identify the exact path taken between the network nodes. Once a general path is identified as having a problem, other telemetry data may be generated and/or used (e.g., between switches or other network nodes) to narrow down the problem, as described in more detail below.

A path P is defined by two network nodes. For example, if packets are sent from endpoint A to endpoint B, the path P could be defined by any suitable path over the network between the endpoint A and endpoint B. Endpoint A adds PSNs and path identifiers at layer 2/3 to packet headers. The path identifiers may identify endpoints A and B based on their MAC and/or IP addresses. Endpoint B may identify packets dropped over path P based on the path identifier and the packet sequence numbers of the received packets from endpoint A. Endpoint B also identifies the packets received over path P. Endpoint B may use this data, for example, to request retransmission, or to perform another action such as send telemetry data about the packets that are received and/or dropped over path P to a collector device. Other actions may include generating congestion control data. Based on the network topology, the packets dropped over path P may have been conveyed via a switch C or a switch D, and so on. The data collected by endpoint B at present does not explain whether the dropped packets were dropped on the path via switch C or via switch B. In order to further investigate the path(s) over which the packets were dropped, other devices in the network may be used to find one or more sub-paths S of path P. For example, packets sent by endpoint A may be received by switches C and D. Switches C and D may identify packets dropped over the paths from endpoint A to switches C and D, respectively, based on the PSNs of the packets and the path identifier of the packets. Switches C and D may add PSNs to the packets at layer 2/3 and add path IDs to the packets. Switches C and D may add new path IDs to the packets, e.g., based on the MAC and/or IP addresses of switches C and D, respectively, and the MAC and/or IP addresses (or other ID data) of the endpoints, e.g., endpoint B. In some cases, switches C and D may augment existing path IDs in the packets with additional path IDs, e.g., based on the MAC and/or IP addresses of switches C and D, respectively. Endpoint B may identify packets dropped over the paths from switches C and D, respectively, to endpoint B, based on the PSNs and the path IDs of the packets at layer 2/3. It may be found that the packet drops over path P are caused by a problem between switch D and endpoint B. This information may be used by a network administrator to correct the problem, such as resetting or replacing switch D or replacing a network connection, and so on.

The above example is simplistic, and a network path may include various levels of switches and many possible paths between endpoints over the network. Different paths and sub-paths over the network may be analyzed by different network nodes adding path identifiers and PSNs to packets for receipt by different network nodes. For example, a path from an endpoint to a switch, and/or a path from one switch to another switch, and/or a path from a switch to an endpoint may be analyzed.

In some cases, the internal behavior of a switch may be investigated. For example, packets arrive at input ports of switch D and are forwarded to output ports of switch D for forwarding over the network to one or more switches and/or one or more endpoints. The input ports of the switch D and the output ports of the switch D may be considered as network nodes. The internal paths from the input ports to the output ports may be considered as different paths across the switch. For example, the path from input port A to output port C is one path, and the path from input port A to output port B is another path, and so on. The input ports may add path IDs and per-path PSNs to packets. The path ID may include the ID of the input port sending the packet, and the ID of the output port receiving the packet. The output ports may then identify dropped packets per path based on the path IDs and the PSNs and perform an action based on the packet data (e.g., sending data indicative of a percentage of dropped packets to a collector node for analysis). The packet data may be used to identify an internal problem of the switch and address the problem. For example, the identified problematic internal switch path may be avoided, or the switch may be reset, repaired, or replaced. An orchestrator could use the above information, e.g., to decide not to use a given path in a switch. The data could be used in routing algorithms and network optimizers.

The above system allows path state to be identified between different network nodes (and not just between endpoints) by leveraging layer 2 or 3 data such as path ID and PSNs. This also has the advantage over using QPs as path identifiers as QPs would result in a lot of data to track, and would not provide path state information for devices (such as network switches) that cannot operate at layer 4. The path identifier at layer 2 or 3 when used to define a path between endpoint devices effectively combines many QPs into a single context and is easier to track. For example, 50 different paths may include 1,000 QPs.

A network node may be any device or element within a network that is capable of sending, receiving, or forwarding data. This includes a variety of components, both physical and logical, within the network infrastructure. The following are examples of what may constitute a network node: a network interface card or controller (NIC), which is a physical device in a computer or other device that enables connectivity to a network, each NIC being identified by a unique address (MAC address) on the local network; a switch, which is a network device that connects multiple devices on a local area network (LAN), forwarding data between the network devices based on MAC addresses; a router, which is a device that connects different networks, often acting as an intermediary between a local network and external networks such as the internet, and routing data based on IP addresses; a port of a device, such as a port of a switch or router, in which the individual ports can also be considered nodes, where the ports are entry or exit points for data on the device, and act as separate network points for devices to connect; and/or access points (APs) for wireless devices that allow devices to connect to a wired network through Wi-Fi and function as a network node within a wireless network. In essence, any physical or logical element that can send, receive, or direct data traffic in a network may be considered a network node. This can include devices like switches, routers, firewalls, and even individual ports on those devices.

The state of paths in a network refers to the status or condition of the routes or connections that data takes from one point to another within a network. This includes both the interconnects (links or connections between devices) and the network devices (such as switches, routers, and other intermediary devices). The “state” typically describes the current operational condition and performance of these paths.

The state of an interconnect or link could include any one or more of the following: active or inactive; indicative of a bandwidth capacity or maximum data transfer rate; a latency, e.g., delay in the transmission of data; error rate, e.g., the number of transmission errors occurring over the link; whether the link is experiencing network congestion, leading to slower data transfer or packet loss; and/or redundancy, e.g., whether alternate paths exist to route data if the primary link fails (relevant for fault tolerance in the network).

The state of a network device may include any one or more of the following: operational status, e.g., whether the device is running or down, operational, in maintenance mode, or completely offline; forwarding state, e.g., on switches, the state of the forwarding table (or MAC address table) determines how packets are forwarded based on destination MAC addresses; interface status, e.g., the status of each individual port on the network device (whether ports are up, down, or administratively disabled); and/or load/capacity, e.g., whether the device is handling more traffic than it is capable of, which could lead to overload, affecting performance.

### System Description

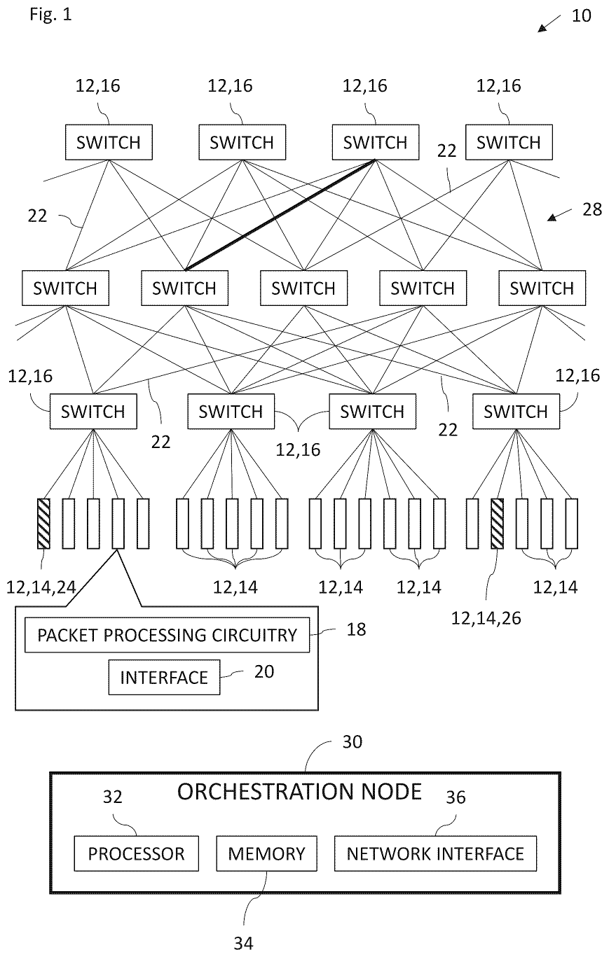

Reference is now made to FIG. 1, which is a block diagram view of a computer system 10 constructed and operative in accordance with an embodiment of the present disclosure.

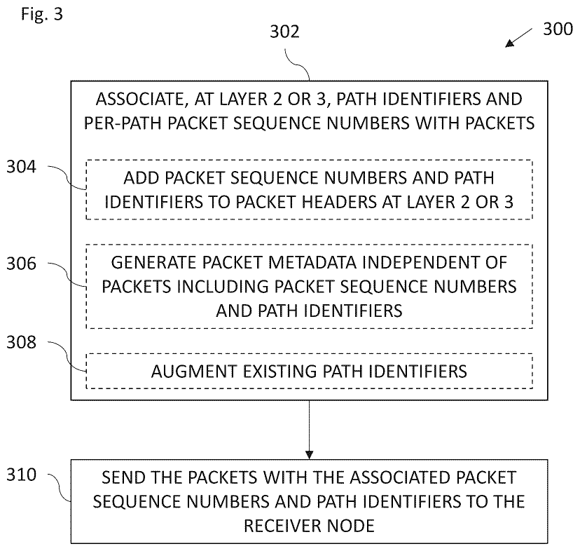

The system 10 includes a plurality of network nodes 12 only some of which are labeled for the sake of simplicity. The network nodes 12 may include any suitable network node, such as an endpoint device 14 or a network switch 16. The network nodes 12 are connected via links 22 (or interconnects) (only some of which are labeled for the sake of simplicity), so that the network nodes 12 are connected via links 22 in a network 28. Each node 12 includes packet processing circuitry 18 and an interface 20 described in more detail with reference to FIGS. 3-5.

FIG. 1 shows two shaded network nodes 12, one is an endpoint device 24 and another is an endpoint device 26. It can be seen from the topology shown in FIG. 1, that if endpoint device 24 sends packets to endpoint device 26, the packets pass through at least three network switches 16 and may take different routes over the network 28.

In order to analyze the state of network paths in network 28, data is associated with packets at layer 2 or 3 of Open Systems Interconnection (OSI) by sender nodes of network nodes 12, and the layer 2 or 3 data of the packets is analyzed by receiver nodes of network nodes 12. One or more of the network nodes 12 may be assigned to be a sender node, and one or more of the network nodes 12 may be assigned to be a receiver node, during any time period. The assignment of the network nodes 12 as sender nodes or receiver nodes may change over time to analyze different paths and sub-paths over network 28.

A sender node may refer to one of the endpoint devices 14 (e.g., endpoint device 24) that sends a packet, or to one of the switches 16 or a port of a switch or any suitable network node that forwards the packet. A receiver node may refer to one of the endpoint devices 14 (e.g., endpoint device 26) that receives a packet, or to one of the switches or a port of a switch or any suitable network node that receives the packet for forwarding to another network node.

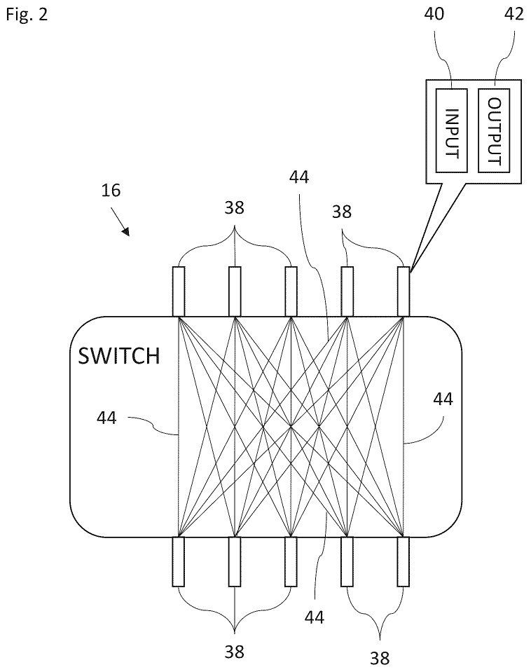

The network nodes 12 assigned to be sender nodes are configured to associate, at layer 2 or 3 of Open Systems Interconnection (OSI) model, (at least a portion of) path identifiers and (at least a portion of) per-path packet sequence numbers (PSNs) with packets. For example, packets to be sent over path A by sender X may be assigned sequential packet sequence numbers, such as 0, 1, 2, 3, and so on, and packets to be sent over path B by sender X may be assigned sequential packet sequence numbers, such as 0, 1, 2, 3, and so on. The path identifiers identify paths from the sender nodes to receiver nodes. The path identifiers may be based on MAC or IP addresses of the sender nodes and receiver nodes or using any other suitable identification scheme. The path identifiers and PSNs are generally added to the packet headers of the packets at layer 2 or 3. When the paths are internal to a switch (as described in more detail with reference to FIG. 2), the path identifiers and PSNs may optionally be added to packet metadata associated with, but not disposed in, the packets. The network nodes 12 assigned to be sender nodes are configured to send the packets with the associated packet sequence numbers and path identifiers to the receiver nodes.

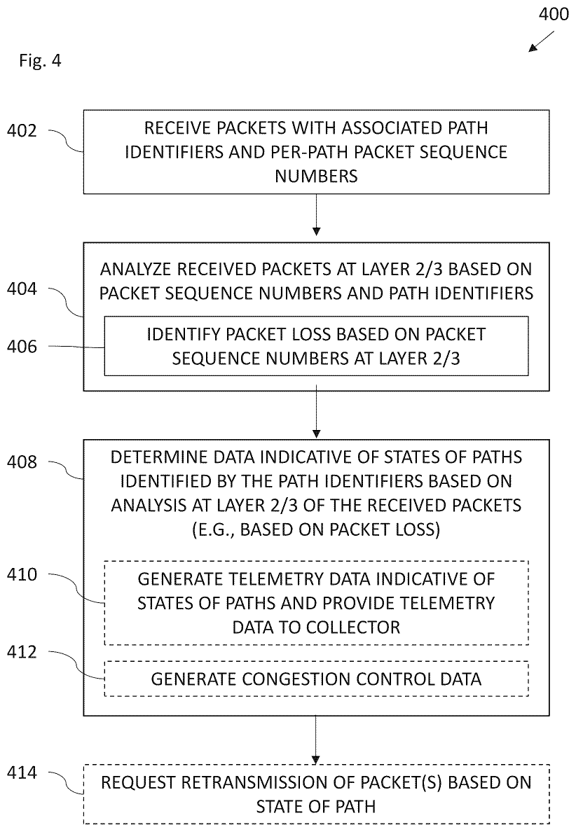

The network nodes 12 assigned to be receiver nodes are configured to receive from the sender nodes the packets with the associated path identifiers and per-path packet sequence numbers, analyze the received packets at the layer 2 or 3 based on (at least a portion of) the packet sequence numbers and (at least a portion of) the path identifiers, and determine data indicative of states of paths identified by the path identifiers based on the analysis at layer 2 or 3 of the received packets. The above steps are described in more detail with reference to FIG. 4.

The receiver nodes may be configured to identify packet loss between the sender nodes and the receiver nodes based on the packet sequence numbers at layer 2 or 3 and determine data indicative of the states of the paths based on the identified packet loss. For example, if one of the receiver nodes receives packets with PSNs 0, 1, and 3 for path A, but does not receive the packet with PSN 2 for path A, then it may be assumed that packet 2 has been dropped. In some embodiments, the receiver nodes may maintain a count of received packets and dropped packets for each path, or compute a receive rate or drop rate for each path, and so on.

In some embodiments, the receiver nodes may be configured to generate telemetry data indicative of the states of the paths (e.g., receive rate or count, drop rate or count) identified by the path identifiers based on the analysis of the receiver packets, and provide the telemetry data to a collector to perform network analysis. The network analysis may result in a decision to perform analysis of a sub-path of the network 28 to further narrow down the source of a network problem.

In some embodiments, the receiver nodes may be configured to generate congestion control data based on state(s) of a given path or paths based on the analysis at layer 2 or 3 of the received packets. In some embodiments, the receiver nodes may be configured to request retransmission of one or more given packets based on the state(s) of the path(s) based on the analysis at layer 2 or 3 of the received packets.

The receiver nodes, which may include one or more of the endpoint devices 14 and/or one or more of the network switches 16, may be configured to receive the packets over network 28 from the sender nodes, which may include one or more endpoint devices 14 and/or one or more of the network switches 16. In other words, a receiver node may be one of the endpoint devices 14 receiving packets from a sender node, which is one of the network switches 16 or one of the endpoint devices 14. A sender node may be one of the endpoint devices 14 or one of the network switches 16 sending packets to a receiver node, which may be one of the network switches 16 or one of the endpoint devices 14.

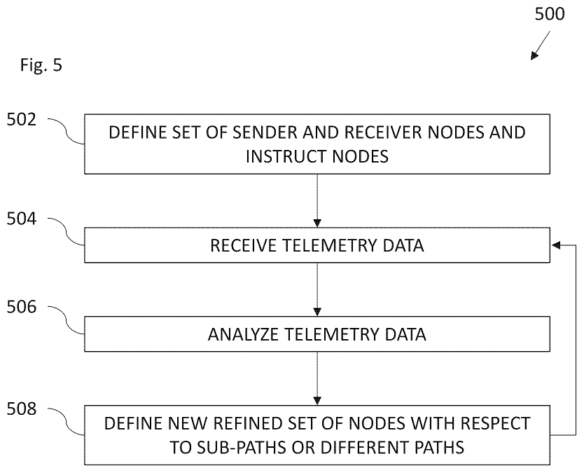

The system 10 may also include an orchestration node 30, which may include a processor 32, a memory 34, and a network interface 36. The memory 34 may be configured to store data used by processor 32. The orchestration node 30 may be part of one of the network nodes 12 or a separate node in network 28. In some of the embodiments, the functionality of the orchestration node 30 may be distributed among two or more of the network nodes 12. The orchestration node 30 is described in more detail with reference to FIG. 5.

Reference is now made to FIG. 2, which is a block diagram view of one of the network switches 16 in the system 10 of FIG. 1. The network switch 16 includes ports 38. Each port 38 may include an input port 40 configured to receive packets from the network 28 and an output port 42 configured to send packets over the network 28. Internally, the network switch 16 includes links 44 (only some labeled for the sake of simplicity) connecting each input port 40 to each output port 42.

In some cases, the internal behavior of the switch 16 may be investigated. Packets arrive at input ports 40 of the switch 16 and are forwarded to output ports 42 the network switch 16 for forwarding over the network 28 to one or more other switches 16 and/or one or more endpoints 14. The input ports 40 of the switch 16 and the output ports 42 of the switch 16 may be considered as network nodes 12. The internal paths from the input ports 40 to the output ports 42 may be considered as different paths across the switch 16. For example, the path from input port A to output port C is one path, and the path from input port A to output port B is another path, and so on. The input ports 40 (which comprise packet processing circuitry 18 and interface 20) may add path IDs and per-path PSNs to packets to be forwarded across the network switch 16. The path ID may include the ID of the input port 40 sending the packet and an ID of the output port 42 receiving the packet. The output ports 42 may then identify dropped packets per path based on the path IDs and the PSNs and perform an action based on the packet data (e.g., sending telemetry data indicative of a percentage of dropped packets to a collector node for analysis, or generating congestion control data). The packet data may be used to identify an internal problem with the switch 16 and address the problem. For example, the identified problematic internal switch path may be avoided, or the switch 16 may be reset, repaired, or replaced. The orchestration node 30 may use the above information, e.g., to decide not to use a given path in a switch. The data could be used in routing algorithms and network optimizers.

Reference is now made to FIG. 3, which is a flowchart 300 including steps in a method of operation of a sender node of the network nodes 12 in the system 10 of FIG. 1. The packet processing circuitry 18 of the sender node is configured to associate, at layer 2 or 3 of Open Systems Interconnection (OSI) model, (at least a portion of) path identifiers and (at least a portion of) per-path packet sequence numbers with packets (block 302). The path identifiers identify paths from the sender node to receiver nodes and may include the MAC and/or IP addresses of the sender node and the respective receiver nodes. For example, the path ID of packets to be sent from sender node A to receiver node B may include the MAC or IP addresses of sender node A and receiver node B, and so on.

In some embodiments, the packet processing circuitry 18 of the sender node is configured to add (at least a portion of) the path identifier and (at least a portion of) PSN for a given packet to the packet header at layer 2 or 3 of the given packet (block 304). For example, the path identifier and PSN could be added to IPv6 flow label field in the IPV6 header. By way of another example, the path identifier and PSN could be added to any suitable L2 tag in a layer 2 header or in a CSIG header. For example, the path identifier may be added to the IPV6 flow label field and the lower 12 bits of the UDP source port.

In some embodiments, for example, where the path identify and PSNs are associated with packets by the input ports 40 of network switch 16 and analyzed by the output port 42 of the network switch 16, the packet processing circuitry 18 of the sender node (e.g., one of the input ports 40) is configured to generate packet metadata (at layer 2 or 3) independent of the packets, and add the path identifiers and the PSNs to the metadata such that the packet metadata is associated with the packets without adding the packet metadata to the packets (block 306). The packet metadata includes the path identifiers and PSNs. For example, for a given packet, packet metadata including a path identifier and PSN may be generated for the given packet without adding the packet metadata to the packet header. The packet processing circuitry 18 of the sender node is configured to add a path identifier and a PSN associated with a given packet to metadata associated with that packet at layer 2 or 3.

In some embodiments, the interface 20 of the sender node is configured to receive the packets from other nodes in network 28, and the packet processing circuitry 18 is configured to augment existing path identifiers of the packets (block 308) based on the paths between the sender node and the receiver nodes of the packets. For example, if a packet is sent from an endpoint device with path ID A, network switch A receiving the packet may augment the path ID with an ID of switch A and optionally with the ID of another switch to which the packet is being sent, e.g., switch B.

The interface 20 of the sender node is configured to send the packets with the associated packet sequence numbers and path identifiers to the receiver nodes (310). In some embodiments, the interface 20 of the sender node (which may be one of the network switches 16 or one of the endpoint devices 14) is configured to send the packets over network 28 to receiver nodes that include at least one endpoint device 14 and/or at least one network switch 16.

In some embodiments, the sender node is comprised in input port 40 of network switch 16, and the receiver nodes are comprised in respective output ports 42 of the same network switch 16. The path identifiers associated with the packets by the input port 40 identify the paths between the input port 40 and the output ports 42 of the switch 16.

Reference is now made to FIG. 4, which is a flowchart 400 including steps in a method of operation of a receiver node of the network nodes 12 in the system 10 of FIG. 1. The interface 20 of the receiver node is configured to receive from sender nodes packets with associated path identifiers and per-path packet sequence numbers (block 402). At least a portion of the received path identifiers and at least a portion of the packet sequence numbers are associated at layer 2 or 3 of Open Systems Interconnection (OSI) model with the received packets.

In some cases, the interface 20 of the receiver node (which may be one of the network switches 16 or one of the endpoint devices 14) is configured to receive the packets over network 28 from the sender nodes (which may include one or more of the network switches 16 and/or one or more of the endpoint devices 14). The path identifiers and per-path PSNs are generally included in the respective packet headers of the packets.

In cases where the packets are being received from sender nodes which are comprised in respective input ports 40 of one of the network switches 16 by output port 42 of the same network switch 16, the path identifiers identify paths between the input ports 40 and the output port 42 of that network switch 16. The received path identifiers and per-path PSNs may be included in the packet headers of the received packets. Alternatively, or additionally, the path identifiers and per-path PSNs may be included in packet metadata which is associated with the packets but not included in the received packets.

The packet processing circuitry 18 of the receiver node is configured to analyze the received packets at the layer 2 or 3 based on (at least a portion of) the packet sequence numbers and (at least a portion of) the path identifiers (block 404). In some embodiments, the packet processing circuitry 18 of the receiver node is configured to identify packet loss between the sender nodes and the receiver node based on (at least a portion of) the packet sequence numbers at layer 2 or 3 (block 406). For example, if the receiver node receives packets with PSNs 0, 1, and 3 for path A, but does not receive the packet with PSN 2 for path A, then it may be assumed after a certain time period that packet 2 has been dropped. In some embodiments, the receiver node may maintain a count of received packets and dropped packets for each path, or compute a receive rate and/or drop rate for each path, and so on, and/or maintain any other suitable statistics related to packet receipt and/or packet drop for different paths.

The packet processing circuitry 18 of the receiver node is configured to determine data indicative of states of paths identified by the path identifiers based on the analysis at the layer 2 or 3 of the received packets (block 408). The data indicative of the states of the paths, may include a receive rate and/or drop rate per path, and/or of indications of the health of the paths based on a score from 0 to 10, for example, and/or an indication of the estimated congestion of the paths or the estimated bandwidth of the paths, and/or any suitable data which provides indications of the states of the paths. In some embodiments, the packet processing circuitry 18 of the receiver node is configured to determine the data indicative of the states of the paths based on the identified packet loss. For example, if packet loss is more than 50% for a given path, the path may be indicated as a “sick” path, or be assigned a health score of 5, or be indicated as having congestion with level X, or having a bandwidth of level Y, and so on.

In some embodiments, the packet processing circuitry 18 of the receiver node is configured to generate telemetry data indicative of the states of the paths identified by the path identifiers based on the analysis of the received packets (block 410). The packet processing circuitry 18 of the receiver node is configured to provide the telemetry data to a collector (e.g., orchestration node 30) to perform network analysis.

In some embodiments, the packet processing circuitry 18 of the receiver node is configured to generate congestion control data based on the state(s) of the path(s) found during the analysis at the layer 2 or 3 of the received packets (block 412).

In some embodiments, the packet processing circuitry 18 of the receiver node is configured to request retransmission of one or more given packets based on the state(s) of the path(s) found during the analysis at the layer 2 or 3 of the received packets (block 414).

In practice, some or all of the functions of packet processing circuitry 18 may be combined in a single physical component or, alternatively, implemented using multiple physical components. These physical components may comprise hard-wired or programmable devices, or a combination of the two. In some embodiments, at least some of the functions of the packet processing circuitry 18 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 5, which is a flowchart 500 including steps in a method of operation of an orchestration node in the system of FIG. 1. The processor 32 of the orchestration node 30 is configured to define an initial set of the sender nodes and the receiver nodes for collection of an initial set of the telemetry data indicative of the state of some of the paths (block 502). The orchestration node 30 configures the sender nodes to associate the path IDs and the per-path PSNs with packets and the receiver nodes to analyze the PSNs based on the path IDs to provide telemetry data to the orchestration node 30. Each of the sender nodes performs the steps of the method described with reference to FIG. 3, and each of the receiver nodes performs the steps of the method described with reference to FIG. 4.

The network interface 36 of the orchestration node 30 is configured to receive the initial set of the telemetry data (block 504) from the receiver nodes. The processor 32 of the orchestration node 30 is configured to analyze the initial set of the telemetry data to determine that one or more given paths are unhealthy (block 506). The processor 32 of the orchestration node 30 is configured to define another set of the sender nodes and the receiver nodes to generate an additional set of the telemetry data with respect to possible sub-paths of the given path (block 508). For example, if a path is defined as unhealthy, the part of the path which is unhealthy may still be unknown. The orchestration node 30 may define the other set of sender nodes as different devices, such as network switches 16, and receiver nodes as network switches 16 and/or endpoint devices 14, in order to further analyze the health of sub-paths of the path.

The orchestration node 30 configures the new sender nodes to associate the path IDs and the per-path PSNs with packets, and the new receiver nodes to analyze the PSNs based on the path IDs to provide telemetry data to the orchestration node 30. Each of the new sender nodes performs the steps of the method described with reference to FIG. 3, and each of the new receiver nodes performs the steps of the method described with reference to FIG. 4. It should be noted that the new receiver nodes or the new sender nodes may include at least some of the previously assigned receiver nodes or sender nodes.

The network interface 36 of the orchestration node 30 is configured to receive the additional set of the telemetry data (block 504). The processor 32 of the orchestration node 30 is configured to analyze the additional set of the telemetry data of the sub-paths to determine that one of the sub-paths is unhealthy (block 506), and so on. The step of block 508 may be repeated to further narrow down the problem in the path or sub-path, and followed by the step of blocks 504-506. The steps of blocks 504-508 may be repeated as many times as determined by orchestration node 30.

In practice, some or all of the functions of processor 32 may be combined in a single physical component or, alternatively, implemented using multiple physical components. These physical components may comprise hard-wired or programmable devices, or a combination of the two. In some embodiments, at least some of the functions of processor 32 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

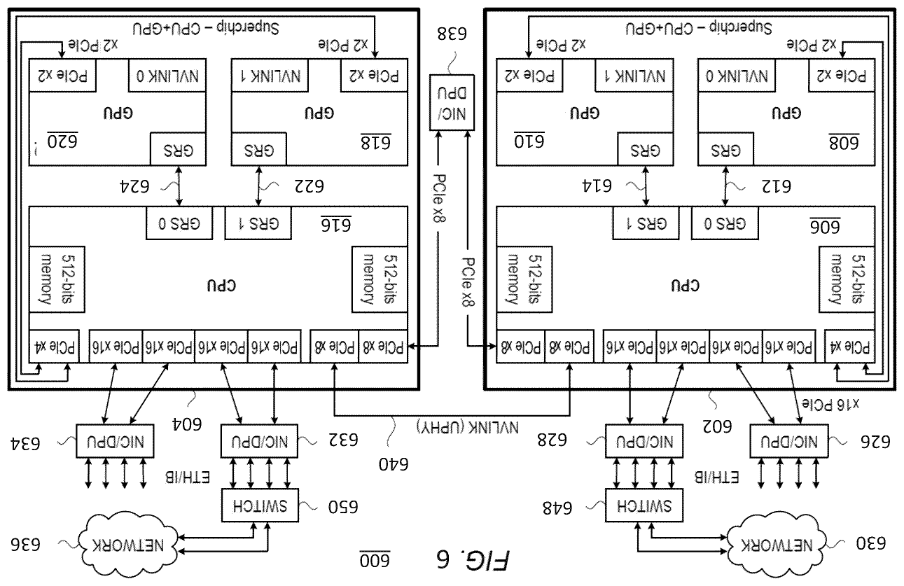

Reference is now made to FIG. 6, which is a block diagram that schematically illustrates a computing system 600, e.g., a data center or a High-Performance Computing (HPC) cluster, in accordance with an embodiment of the present disclosure. The network nodes 12 described with reference to FIGS. 1-5 may be nodes in computer system 600.

System 600 comprises a plurality of subsystems, e.g., multiple processing devices coupled to each other, multiple network devices, and multiple networks, according to at least one embodiment. Computing system 600 is designed with multiple integrated circuits (referred to as processing devices), where each integrated circuit can include one or more CPUs and GPUs, forming a powerful and flexible architecture.

The various processing devices are interconnected via an NVLink or other high-speed interconnect (e.g., Ethernet in lossy mode), enabling high-speed communication between the subsystems, and are also connected through a NIC or DPU to ensure efficient data transfer across computing system 600 and to one or more external networks 630, 636. In the present example, system 600 comprises a packet switch 648 that connects NIC/DPU 628 to network 630, and a packet switch 650 that connects NIC/DPU 632 to network 636.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs.

FIG. 6 also demonstrates an example architecture of a multi-GPU architecture. As illustrated in the figure, computing system 600 includes a processing device 602 with a multi-GPU architecture. In particular, processing device 602 may be a system-on-chip and includes multiple subsystems such as a CPU 606, a GPU 608, and a GPU 610. CPU 606 can be coupled to GPU 608 via a die-to-die (D2D) or chip-to-chip (C2C) interconnect 612, such as a Ground-Referenced Signaling interconnect (GRS interconnect). CPU 606 can be coupled to GPU 610 via a D2D or C2C interconnect 614. CPU 606 can also couple to GPU 608 and GPU 610 via PCIe interconnects.

CPU 606 can be coupled to one or more NICs or DPUs, which are coupled to one or more networks. For example, as illustrated in FIG. 6, CPU 606 is coupled to a first NIC/DPU 626, which is coupled to a network 630. CPU 606 is also coupled to a second NIC/DPU 628, which is coupled to network 630 via switch 648. NIC/DPU 626 and NIC/DPU 628 can be coupled to network 630 over Ethernet (ETH), NVLINK or InfiniBand (IB) connections, for example.

Computing system 600 also includes a processing device 604 with a multi-GPU architecture. In particular, processing device 604 includes multiple subsystems including a CPU 616, a GPU 618, and a GPU 620. CPU 616 can be coupled to GPU 618 via a D2D or C2C interconnect 622. CPU 616 can be coupled to GPU 620 via a D2D or C2C interconnect 624. CPU 616 can also couple to GPU 618 and GPU 620 via PCIe interconnects. CPU 616 can be coupled to one or more NICs or DPUs, which are coupled to one or more networks. For example, as illustrated in FIG. 6, CPU 616 is coupled to a first NIC/DPU 632, which is coupled to a network 636. CPU 616 is also coupled to a second NIC/DPU 634, which is coupled to network 636 via switch 650. NIC/DPU 632 and NIC/DPU 634 can be coupled to network 636 over Ethernet (ETH), NVLINK or InfiniBand (IB) connections.

In at least one embodiment, processing device 602 and processing device 604 can communicate with each other via a NIC/DPU 638, such as over PCIe interconnects. Processing device 602 and processing device 604 can also communicate with each other over a high-bandwidth communication interconnect 640, such as an NVLink interconnect or other high-speed interconnects. The packet switches in FIG. 6 may comprise, for example, Nvidia Quantum-2 or Spectrum switches. The NICs/DPUs in the figure may comprise, for example, Nvidia Bluefield DPUs.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A sender node, comprising:
packet processing circuitry to associate, at layer 2 or 3 of Open Systems Interconnection (OSI) model, at least a portion of path identifiers and at least a portion of per-path packet sequence numbers with packets, wherein: the path identifiers identify paths from the sender node to receiver nodes; and
an interface to send the packets with the associated packet sequence numbers and path identifiers to the receiver nodes.

2. The sender node according to claim 1, wherein the packet processing circuitry is to add the path identifiers and the per-path packet sequence numbers to packet headers of the packets at layer 2 or 3.

3. The sender node according to claim 1, wherein the packet processing circuitry is to add the path identifiers and the per-path packet sequence numbers to metadata associated with packets at layer 2 or 3.

4. The sender node according to claim 1, wherein the interface is to send the packets over a network to the receiver nodes which include at least one endpoint device, the sender node being a network switch or an endpoint device.

5. The sender node according to claim 1, wherein the interface is to send the packets over a network to the receiver nodes, the receiver nodes including at least one network switch.

6. The sender node according to claim 5, wherein the sender node is a network switch.

7. The sender node according to claim 1, wherein the sender node is comprised in an input port of a network switch, and the receiver nodes are comprised in respective output ports of the network switch, the path identifiers identifying the paths between the input port and the output ports of the switch.

8. The sender node according to claim 1, wherein:
the interface is to receive the packets from other nodes in a network; and
the packet processing circuitry is to augment existing path identifiers of the packets based on the paths between the sender node and the receiver nodes of the packets.

9. A receiver node, comprising:
an interface to receive from sender nodes packets with associated path identifiers and per-path packet sequence numbers, at least a portion of the path identifiers and at least a portion of the packet sequence numbers being associated at layer 2 or 3 of Open Systems Interconnection (OSI) model with the packets; and
packet processing circuitry to:
analyze the received packets at the layer 2 or 3 based on the at least portion of the packet sequence numbers and the at least portion of the path identifiers; and
determine data indicative of states of paths identified by the path identifiers based on the analysis at the layer 2 or 3 of the received packets.

10. The receiver node according to claim 9, wherein the path identifiers and the per-path packet sequence numbers are received from the sender nodes in packet headers of the packets at layer 2 or 3.

11. The receiver node according to claim 9, wherein the path identifiers and the per-path packet sequence numbers are included in metadata associated with packets at layer 2 or 3.

12. The receiver node according to claim 9, wherein the packet processing circuitry is to:
identify packet loss between the sender nodes and the receiver node based on the packet sequence numbers at layer 2 or 3; and
determine the data indicative of the states of the paths based on the identified packet loss.

13. The receiver node according to claim 9, wherein the packet processing circuitry is to:
generate telemetry data indicative of the states of the paths identified by the path identifiers based on the analysis of the received packets; and
provide the telemetry data to a collector to perform network analysis.

14. The receiver node according to claim 9, wherein the packet processing circuitry is to generate congestion control data based on a state of a given one of the paths based on the analysis at the layer 2 or 3 of the received packets.

15. The receiver node according to claim 9, wherein the packet processing circuitry is to request retransmission of one or more given packets based on a state of a given one of the paths based on the analysis at the layer 2 or 3 of the received packets.

16. The receiver node according to claim 9, wherein the interface is to receive the packets over a network from the sender nodes, the sender nodes including at least one endpoint device, the receiver node being a network switch or an endpoint device.

17. The receiver node according to claim 9, wherein the interface is to receive the packets over a network from the sender nodes, the sender nodes including at least one network switch.

18. The receiver node according to claim 17, wherein the receiver node is a network switch.

19. The receiver node according to claim 9, wherein the sender nodes are comprised in respective input ports of a network switch, and the receiver node is comprised in an output port of the network switch, wherein the path identifiers identify the paths between the input ports and the output port of the switch.

20. A system, comprising:
sender nodes to:
associate, at layer 2 or 3 of Open Systems Interconnection (OSI) model, at least a portion of path identifiers and at least a portion of per-path packet sequence numbers with packets, wherein: the path identifiers identify paths from the sender nodes to receiver nodes; and
send the packets with the associated packet sequence numbers and path identifiers to the receiver nodes; and
receiver nodes to:
receive from the sender nodes the packets with the associated path identifiers and per-path packet sequence numbers;
analyze the received packets at the layer 2 or 3 based on the at least a portion of the packet sequence numbers and the at least a portion of the path identifiers; and
determine data indicative of states of paths identified by the path identifiers based on the analysis at layer 2 or 3 of the received packets.

21. The system according to claim 20, wherein the sender nodes are to add the path identifiers and the per-path packet sequence numbers to packet headers of the packets at layer 2 or 3.

22. The system according to claim 20, wherein the sender nodes are to add the path identifiers and the per-path packet sequence numbers to metadata associated with packets at layer 2 or 3.

23. The system according to claim 20, wherein at least one of the receiver nodes is to:
identify packet loss between the sender nodes and the at least one receiver node based on the packet sequence numbers at layer 2 or 3; and
determine the data indicative of the states of the paths based on the identified packet loss.

24. The system according to claim 20, wherein the receiver nodes are to:
generate telemetry data indicative of the states of the paths identified by the path identifiers based on the analysis of the receiver packets; and
provide the telemetry data to a collector to perform network analysis.

25. The system according to claim 20, wherein at least one of the receiver nodes is to generate congestion control data based on at least one state of at least one given one of the paths based on the analysis at the layer 2 or 3 of the received packets.

26. The system according to claim 20, wherein at least one of the receiver nodes is to request retransmission of one or more given packets based on at least one state of at least one given one of the paths based on the analysis at the layer 2 or 3 of the received packets.

27. The system according to claim 20, wherein the receiver nodes are to receive the packets over a network from the sender nodes, the sender nodes including at least one endpoint device, the receiver nodes including at least one network switch or at least one endpoint device.

28. The system according to claim 20, wherein the receiver nodes are to receive the packets over a network from the sender nodes, the sender nodes including at least one network switch.

29. The system according to claim 28, wherein the receiver nodes include at least one network switch.

30. The system according to claim 20, further comprising an orchestration node to:
define an initial set of the sender nodes and the receiver nodes for collection of an initial set of the telemetry data indicative of the state of some of the paths;
receive the initial set of the telemetry data;
analyze the initial set of the telemetry data to determine that a given path is unhealthy;
define another set of the sender nodes and the receiver nodes to generate an additional set of the telemetry data with respect to possible sub-paths of the given path;
receive the additional set of the telemetry data; and
analyze the additional set of the telemetry data of the sub-paths to determine that one of the sub-paths is unhealthy.

31. A method at a sender node, comprising:
associating, at layer 2 or 3 of Open Systems Interconnection (OSI) model, at least a portion of path identifiers and at least a portion of per-path packet sequence numbers with packets, wherein: the path identifiers identify paths from the sender node to receiver nodes; and
sending the packets with the associated packet sequence numbers and path identifiers to the receiver nodes.

32. A method at a receiver node, comprising:
receiving from sender nodes packets with associated path identifiers and per-path packet sequence numbers, at least a portion of the path identifiers and at least a portion of the packet sequence numbers being associated at layer 2 or 3 of Open Systems Interconnection (OSI) model with the packets;
analyzing the received packets at the layer 2 or 3 based on the at least portion of the packet sequence numbers and the at least portion of the path identifiers; and
determining data indicative of states of paths identified by the path identifiers based on the analysis at the layer 2 or 3 of the received packets.
